(19) United States
(12) Patent Application Publication
(10) Pub. No.: US 2007/0297719 A1
(43) Pub. Date: Dec. 27, 2007

(54) Integrated Microlens Reflector And Light Coupler

(75) Inventor: Menachem Nathan, Tel Aviv (IL)

Correspondence Address: Mark M Friedman;C/O Bill Polkinghorn, 9003 Florin Way, Upper Marlboro, MD, 20772, US

(73) Assignee: RAMOT AT TEL-AVIV UNIVERSITY LTD., Tel Aviv (IL)

(21) Appl. No.: 10/572,555

(22) PCT Filed:
(86) PCT No.: PCT/IL04/00884

Related U.S. Application Data
(60) Provisional application No. 60/505,870, filed on Sep. 26, 2003.

(51) Int. Cl. G02B 6/26

(52) U.S. Cl. 385/32

(57) ABSTRACT

A microlens reflector (200) and light coupler comprises a material transparent to light of a predetermined wavelength bound by an envelope with a curved section (202) and at least two non-parallel flat sections (204, 206), the curved section (202) operative to reflect internally light entering the component through one flat section (206), the reflected light directed to leave the component through its other flat section (204). The microlens reflector can reflect and couple light from one optical element into another optical element, e.g. from a waveguide into a detector, and from a light source into a waveguide. Arrays of integrated microlens reflectors (700) may be used to couple optical fibers to on-chip optical waveguides in N×M optical cross-connects and switches, providing simple, true 3-dimensional optical coupling architectures.

### FIELD OF THE INVENTION

This invention relates to integrated optical micro-components, also known as micro-opto-electro-mechanical system (MOEMS) components, and more particularly to MOEMS integrated reflectors/light couplers.

### BACKGROUND OF THE INVENTION

Micro-electro-mechanical system (MEMS) technologies, also known as micro-system-technologies (MST) have undergone rapid development in the past two decades. Optical micro-systems, branded generically as MOEMS are also evolving rapidly. A good recent review of the latter may be found in “Optical MEMS for telecoms” by R. R. A. Syms and D. F. Moore, Materials Today, vol. 5, pp. 26-35, 2002. MOEM systems are characterized by a general miniaturization of known optical elements or components, and by, in some cases, integration of these miniaturized elements on a single chip. One integration trend is that of incorporating light sources, light waveguides (WGs) and light photodetectors (PDs) on a single chip, either monolithically or hybridly. In such an integrated system, light is typically coupled between two different components, for example from the light source (e.g. light emitting diode (LED), or laser) into the WG, and from the WG into the PD (e.g. a PN junction in a semiconductor such as silicon). The coupling is generally quite inefficient In particular, existing schemes and methods of light coupling from the WG into the PD result in efficiencies of a few percent, unless special, complicated and expensive measures are taken. The subject is discussed in more detail in “Monolithic coupling of a SU8 waveguide to a silicon photodiode” by M. Nathan et al., Journal of Applied Physics, Vol. 94, pp. 7932-7934, 2003 and the references cited therein (hereinafter “Nathan 2003”), and in chapter 2 of a thesis “Fabrication and characterization of a monolithic integration between a planar waveguide and a photodiode” by Oren Levy, Tel Aviv University, June 2003 (hereinafter Levy 2003). The complicated and expensive measures mentioned therein include fabrication of anti-reflection elements, fabrication or provision of prisms or mirrors, fabrication of distributed Bragg reflectors (DBR) and gratings, etc.

In a more general case, reflection may be needed to couple light between two components such as two optical fibers. Normally, this is done using concave mirrors, for example as described in U.S. Pat. No. 4,459,022 to Morey and in U.S. Pat. No. 6,031,946 to Bergmann. One can define the general problem as one in which light traveling along a given path in one component (say in the x-direction) needs to be reflected and coupled into a second component not aligned along the same axis as the first (i.e. at some angle to the x-direction). Often, this coupling involves a 90° out-of-plane change in the light path.

Microlenses (ML) and methods for their fabrication are known in the art. In particular, the fabrication of photoresist microlenses with a few micron to a few hundred micron diameters using low cost, mass production lithographic and other technologies is known, see for example M. H. Wu and G. M. Whitesides, J. Micromech. Microeng. 12 (2002) 747-758, U.S. Pat. No. 6,509,140 to Liand and U.S. Pat. No. 6,301,051 to Sankur. An array of 40 μm diameter,semispherical microlenses fabricated by photoresist reflow on a silicon substrate in our laboratory is shown in FIG. 1. The figure also shows a PD buried in the silicon.

Microlenses serve as either refractors or diffractors of light. ML arrays are normally used for enhancing light out-coupling from a LED, or for display intensity enhancement, see the Wu and Whitesides reference above, as well as US patent application US 2003/0020399A1 to Moller and Forrest. Microlenses may be also used as in-couplers (focusers) of external light, i.e. as enhancers of fill factor in infrared focal plane arrays, see. S. Chen et al, Infrared Phys. Technol. vol. 43, pp. 109-112, 2002. However, there is no known use of a ML as a light reflector, i.e. as a component that receives light emitted from one element and reflects it by total internal reflection (acting essentially as a mirror) into another element.

There is thus a need for, and it would be advantageous to have low cost, simple to make micro-reflectors that facilitate and enhance the coupling of light between two similar or dissimilar micro-optical components.

### SUMMARY OF THE INVENTION

The present invention discloses a microlens operative to act as a light reflector and coupler, and devices and systems based thereon. For simplicity, the reflecting ML of the present invention is referred to henceforth as “ML reflector” or “MLR”. The MLR of the present invention is a micro-optical element made of a medium transparent to the reflected/coupled light, which acts essentially as a micro-mirror for light propagating internally in it, through total internal reflection (TIR) from its external envelope. The MLR can couple light between two optical elements having orthogonal or non-orthogonal main light propagation axes. These two elements will henceforth be referred to as “coupled optical elements”. The coupled optical elements may exemplarily be a WG and a PD, or a light source (e.g. a LED or a vertical surface cavity emitting laser (VCSEL)) and a WG. More specifically, a MLR according to the present invention can act as a mirror that reflects and couples light from a WG into a PD with an axis orthogonal to the light propagation axis in the WG. In another embodiment described in detail, a MLR couples light emitted from a vertically positioned optical fiber into a horizontal WG or optical fiber. In the most general case, the coupled optical components need not be orthogonal to each other, but just have non-parallel main light propagation axes.

Preferably, the MLR is made of a reflowed photoresist. Optionally, the MLR may be covered on its external surface with a reflective thin film material to enhance the reflecting action. The MLR is preferably fabricated to substantially cover an overlap section common to the coupled optical elements. Optionally, the MLR may also cover a non-overlapping section or cover additional areas, particularly a PD area extending beyond an end facet of the WG. Alternatively, the MLR may be made of other materials transparent to the reflected light wavelength, for example various glasses. These materials may be formed into a ML shape using various techniques that include regular and soft lithography (micro-molding). The only requirement of any MLR material according to the present invention is that it can be deposited and formed into an appropriate shape that facilitates total internal reflection of light that enters the MLR from one element, the reflected light directed into the other element.

According to the present invention there is provided a reflecting micro-optical component comprising a material transparent to light of a predetermined wavelength, and an envelope for bounding the material, the envelope including a curved section and at least two non-parallel flat sections, the curved section operative to perform total internal reflection of light entering the component through one flat section, thereby directing the reflected light to leave the component through its other flat section, whereby the reflecting micro-optical component can reflect and couple light from one optical element into another optical element.

According to one feature in the reflecting micro-optical component of the present invention the material is a photoresist, whereby the reflecting micro-optical component is a photoresist microlens.

According to another feature in the reflecting micro-optical component of the present invention the material is a glass, whereby the reflecting micro-optical component is a glass microlens.

According to yet another feature in the reflecting micro-optical component of the present invention, the component further comprises a thin reflecting layer covering the curved envelope section.

According to the present invention there is provided a reflecting micro-optical component comprising a curved envelope section separating a light transparent material from a first external medium, a first flat envelope section separating the material from a second external medium, and a second flat envelope section positioned substantially vertical to the first flat section and separating the material from a third external medium, whereby light entering the component from the second external medium is reflected from the curved section into the third external medium.

According to the present invention there is provided a microreflector comprising an element made of a material transparent to light of a predetermined wavelength and operative to couple optically to one micro-optical component through a first flat surface and to another micro-optical component through a second flat surface, and a curved envelope section defining a reflective surface of the element, whereby light originating from one of the micro-optical components is reflected internally by the curved envelope section into the other of the micro-optical components.

According to the present invention there is provided a method of coupling light between two micro-optical components, comprising the steps of forming a microlens reflector operative to reflect light from one micro-optical component into the other micro-optical component, and coupling light from one micro-optical component into another, wherein the light is at least partially reflected internally in the microlens reflector on its path between the two micro-optical component.

According to the present invention there is provided a 3D optical interconnection architecture comprising a substrate and a N×M array of microlens reflectors formed on the substrate and operative to couple an array of N optical fibers to M optical WGs in a 90° out-of-plane coupling scheme.

According to the present invention there is provided a 3D optical interconnection architecture comprising a substrate and an array of reflecting micro-optical components formed on the substrate and operative to couple light between a first plurality of N optical components and a second plurality of M optical components, each reflecting micro-component further comprising a material transparent to light of a predetermined wavelength, and an envelope for bounding the material, the envelope comprising a curved section and at least two non-parallel flat sections, the curved section operative to reflect internally light entering the component through one flat section, the reflected light directed to leave the component through its other flat section, whereby the architecture allows true 3D coupling from the first plurality of N optical components to the second plurality of M optical components and from the second plurality of M optical components to the first plurality of N optical components.

### BRIEF DESCRIPTION OF THE DRAWINGS

The invention is herein described, by way of example only, with reference to the accompanying drawings, wherein:

FIG. 1 is a photograph of a circular ML array;

FIG. 2 shows schematically in cross section a MLR of the present invention: (a) with orthogonal flat surfaces; (b) and (c) with non-orthogonal flat surfaces.

FIG. 3 shows a preferred embodiment of an integrated MLR according to the present invention used for coupling light between a WG and a buried PD: a) schematic side view; b) top optical photograph of a WG/MLR/PD assemble (left) and a WG/PD assemble (right); c) enlargement of the WG/MLR/PD assembly in (b);

FIG. 4 shows: (a) experimental results and (b) simulations of the coupling efficiency for the integrated WG/MLR/PD structure of FIG. 3;

FIG. 5 shows schematically a preferred embodiment of an integrated MLR used for coupling light between a vertically emitting light source (VCSEL or LED) and a horizontal WG;

FIG. 5 shows schematically yet embodiment of an MLR of the present invention, used to couple light from a light fiber into a WG;

FIG. 7 shows schematically in cross section in (a) and in an isomeric view (b) an embodiment of an integrated optical chip with a plurality of horizontal WGs coupled through respective MLRs to a similar plurality of vertical fibers;

FIG. 8 shows: (a) a top optical microscope view of an MLR on an oxide membrane covering a silicon hole, the MLR partially overlapping a WG; (b) a row of such MLR/WG structures on top of holes formed in a silicon substrate from the back.

### DETAILED DESCRIPTION OF THE PREFERRED EMBODIMENTS

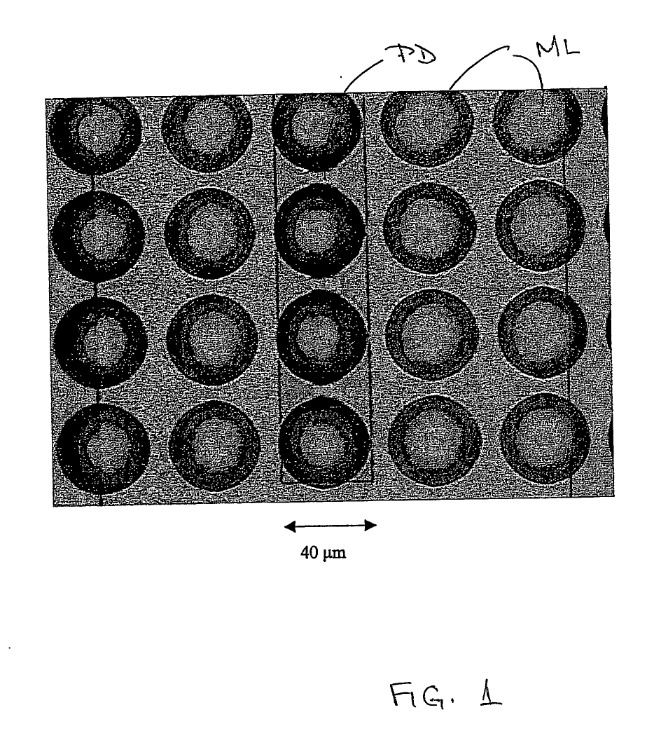

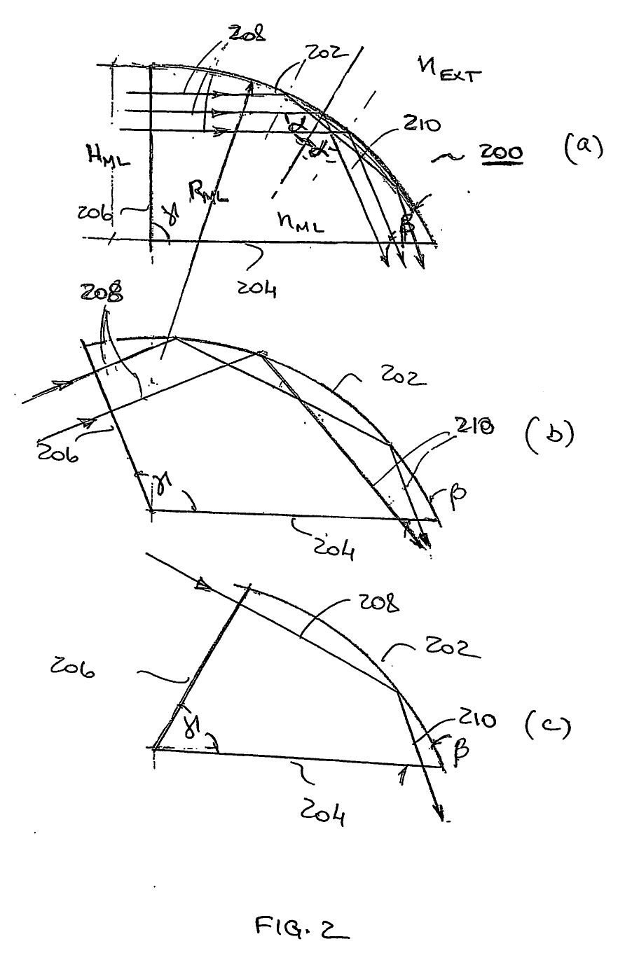

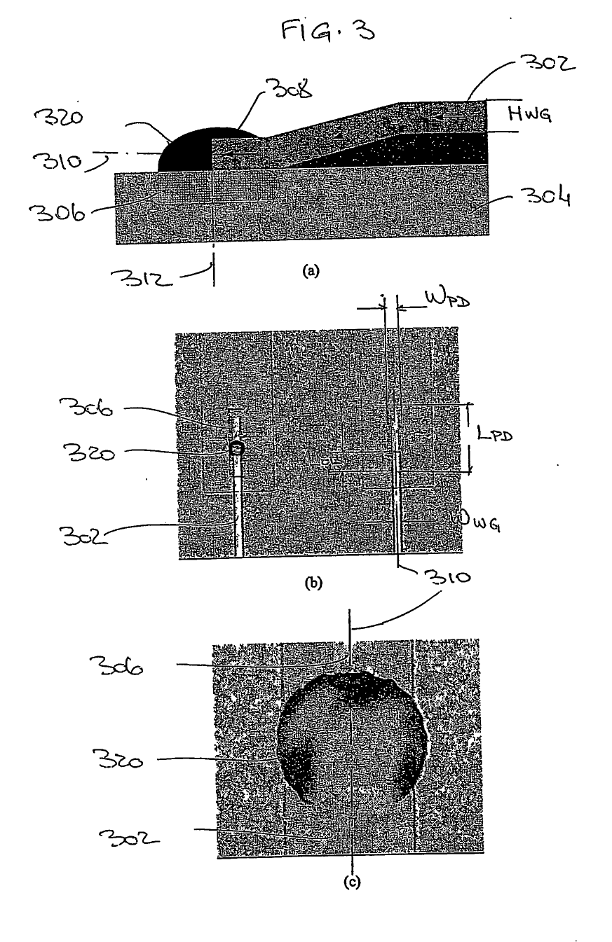

The present invention is of an integrated microlens reflector/light coupler that acts essentially as a micro-mirror, and of devices and systems based thereon. Preferably, the MLR of the present invention is a miniaturized optical component that can be fabricated with low cost mass production techniques, and which facilitates, assists, or enhances the coupling of light between two other miniaturized optical components fabricated using similar technologies. The MLR acts as a mirror for light exiting one of the components (e.g. a WG), reflecting the light into the other component (e.g. a PD). FIG. 2a illustrates schematically the reflection action. The figure shows in cross section a quarter section of a semispherical microlens 200. ML 200 is defined by an external envelope that includes an envelope section 202 operative to perform total internal reflection, a horizontal bottom flat surface section 204, and a vertical side surface section 206. Section 202 is preferably curved and most preferably at least partially semi-spherical. For simplicity, these sections will be referred to henceforth simply as curved surface 202, bottom surface 204 and side surface 206. “Vertical” and “horizontal” are used here exemplarily as a general indication of orthogonality. Note that the two flat sections need not be orthogonal, and as shown in FIGS. 2b and 2c may form an angle γ between them smaller or larger than 90°. To remove any doubt, a “curved” section herein means a section of the envelope with at least one finite radius of curvature, which however can be very large. The at least one radius of curvature is marked R_{ML}. The radius of curvature may not be constant (e.g. the curvature may comprise subsections or segments with different radii). In contrast, a “flat” surface is defined as a surface having a single infinite radius of curvature. The full footprint (circumference or perimeter) of ML 200 on the bottom surface is preferably circular, as shown exemplarily in FIG. 1. The semispherical shape is typical to photoresist MLs but by no means unique. In other embodiments, the ML footprint may be elliptical, rectangular, hexagonal, or of any other shape in which microlenses are known to be fabricated. In principle, for a ML with a very large footprint and small height, the curvature may be very large, approximating a straight line. The ML is further defined by a maximum height H_{ML}, which may range from fractions of a micrometer to a few tens of micrometers. A typical MLR thus looks like a semispherical “cap” or “bubble”. The actual dimensions (diameter, height) and shape of the ML are process-dependent. It is well known in the art that microlenses can be fabricated with different focal lengths. The MLR of the present invention is advantageous in terms of its simplicity, ease of manufacture, mass producibility and low cost. It provides a solution where prior art does not, or where prior art requires expensive and complicated schemes.

ML 200 is made of a material that is substantially transparent to light beams 208 entering it through one of the flat surfaces (e.g. surface 204). Preferably the ML is made of a photoresist that can be reflowed to obtain the required shape, using known processes. Note that for a reflowed photoresist ML, the contact angle β between the curved section and the bottom surface is influenced by the surface tensions of the ML material and the substrate. Alternatively, the ML shape in the photoresist may be formed by soft lithography replication, see. M. V. Kunnnavakkam et al, Appl. Phys. Lett. Vol. 82 pp. 1152-1154, 2003. Further alternatively, the ML may be made of other transparent materials, e.g. glasses, using, micro-molding, reflow and other techniques. These materials may be for example chalcogenide glasses, see. N. P. Eisenberg et al. in Mater Sci. in Semicond. Processing, Vol. 3, pp. 443-448 2000, J. Optoelectron and Adv. Mater. Vol 2, pp. 147-152, 2002 and J. Optoelectron and Adv. Mater. Vol. 4, pp. 405-407, 200), or inorganic-organic sol-gel glasses, see M. He et al., Applied Optics, Vol. 42, pp. 7174-7178, 2003. In general, an MLR of the present invention may be fabricated with any known fabrication method that can be used to form a ML in a light-transparent material.

In use, curved envelope section 202 acts as a reflecting surface for any light ray 208 that enters the MLR through one flat surface (e.g. 206), and which reaches section 202 at an angle α>α_{cr}, where α_{cr} is a critical angle for TIR. The light is reflected internally in the ML. Some reflected rays 210 are directed so that they leave the ML through the other flat surface (e.g. surface 204) after a single reflection. Other rays undergo multiple reflections before leaving the ML. The reverse action is also possible, i.e. light entering the ML through flat surface 204 is reflected internally from curved section 202 and leaves the ML through flat surface 206. The efficiency of the reflecting (coupling) action depends on a number of parameters including the transmittance and refractive index of the lens material and the shape and size of the envelope.

The critical angle for TIR at envelope 202 depends on the refractive index of the ML material n_{ML} and the refractive index of the external (to the ML) medium n_{EXT}. Exemplarily, for an AZ-4562 photoresist ML with index n_{ML}=1.75, bordered by air (n_{EXT}=1), α_{cr}=34.8°. For a glass ML with n_{ML}=1.333 bordered by air, α_{cr}=48.6°. For high refractive index chalcogenide glasses (see Eisenberg et al. above) with n_{ML}=2.3-3.3 bordered by air, α_{cr} is respectively 25.8-17.6°. The reflection efficiency may be enhanced by coating the envelope with a thin reflective layer, e.g. that of a metal such as aluminum, silver, gold, etc. Alternatively, the reflective layer may include reflective structures made of dielectric materials, either single layered or multilayered. The reflective layer is preferably of a thickness normally used in mirror coatings, i.e. from a few tens of Angstroms to a few thousands of Angstroms.

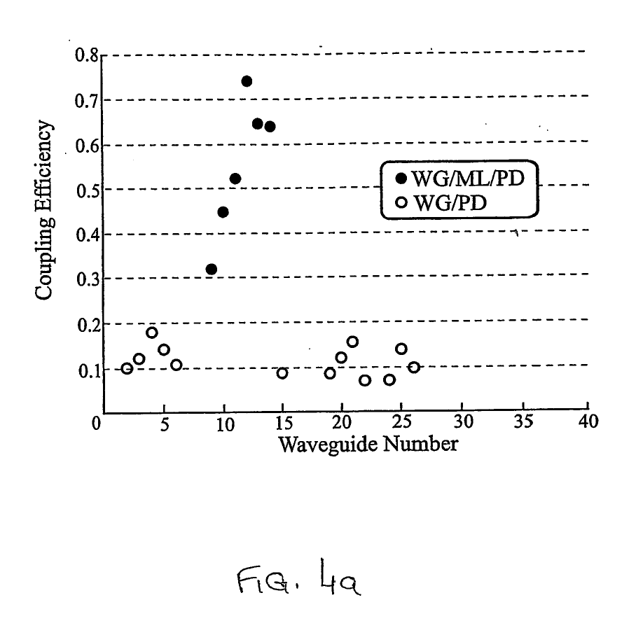

In a preferred embodiment, an MLR of the present invention is used to reflect and couple light from a WG and into a buried photodiode. Preferably, the MLR, WG and PD are integrated monolithically on a single chip, as shown schematically in FIG. 3. Note that although the invention is described in detail re. coupling of WGs to buried PDs, the MLR disclosed herein may be equally useful in coupling light between other micro-optical elements, e.g. between a vertical light emitter (e.g. a VCSEL) and a WG, between a light fiber and a WG, or between two non-aligned WGS (the latter in a geometry similar to that described for optical fibers in U.S. Pat. No. 4,459,022 to Morey and in U.S. Pat. No. 6,031,946 to Bergmann).

FIG. 3 shows a preferred embodiment of an integrated MLR according to the present invention used for coupling light between a WG and a buried PD: a) schematic side view; b) top optical photograph of a WG/MLR/PD assemble (left) and a WG/PD assemble (right); and c) enlargement of the WG/MLR/PD assembly in (b). The figure shows a WG 302 fabricated on a substrate 304, and a PD 306 fabricated in the same substrate. Preferably the substrate is a semiconductor, e.g. silicon substrate, and the PD is a PN junction detector, with the junction plane parallel to the substrate surface. WG 302 has a height H_{WG} and a width W_{WG} that define a rectangular cross section A=H_{WG}×W_{WG}, and ends with an end facet 308 in the vicinity of, or on top of PD 306. Typically, H_{WG} may range from a few thousand Angstroms (less than a micrometer) to tens of micrometers, while W_{WG} may range from one micrometer to a few tens of micrometers. The PD area in the substrate plane is defined by a detector length L_{PD} and a detector width W_{PD}. This area may range from a few to hundreds of square micrometers. In FIG. 3, the WG and the PD are essentially orthogonal to each other, i.e. a length axis 310 of the WG is orthogonal to an axis 312 perpendicular to the PN junction in the PD. In general, the WG and the PD may overlap over a common length L_{OL} and a common overlap area OA=L_{OL}×W (W being the larger of the WG or PD widths), although end facet 308 may be also positioned outside the boundary of the PD (no overlap). The WG is made of a material transparent to light at a wavelength that is absorbed in the PD. In coupling to silicon PDs, examples of such WG materials are silicon nitride, polymers and SU8, the latter being an epoxy photoresist, these examples being by no means limiting. The fabrication and characterization of an integrated SU8 WG/MLR/silicon PD structure is described in Nathan 2003 and in more detail in Levy 2003.

A ML 320, preferably made of a photoresist (e.g. AZ 4562), is formed in the general area of the common WG/PD overlap area. The microlens is fabricated to substantially cover a section of the OA, and, optionally, to cover an additional detector area A_{PD} (not shown) extending beyond end facet 308 of the WG. Note that in the case in which the WG and PD do not overlap (OA=0), the ML is formed so that its coverage area covers a length section of the WG and a length section of the detector. If the ML height equals that of the WG, then in FIG. 3, the ML facet in contact with end facet 308 is essentially equivalent to vertical side surface 206 in FIG. 2a, while horizontal side surface 204 represents the ML footprint covering the PD. In other words, WG length axis 310 is perpendicular to ML side surface 206 and PD axis 312 is perpendicular to ML bottom surface 204.

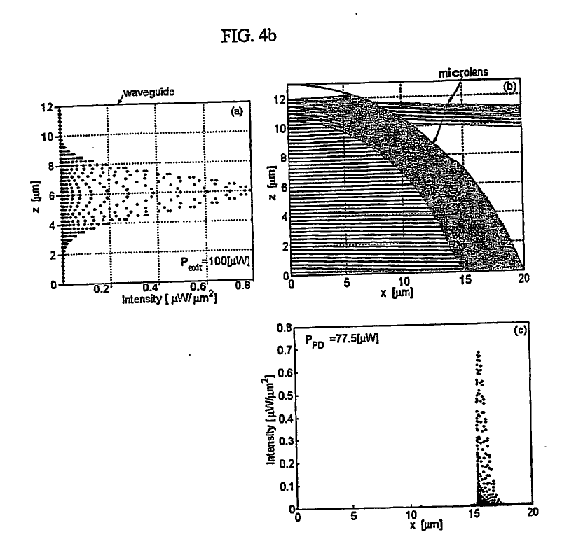

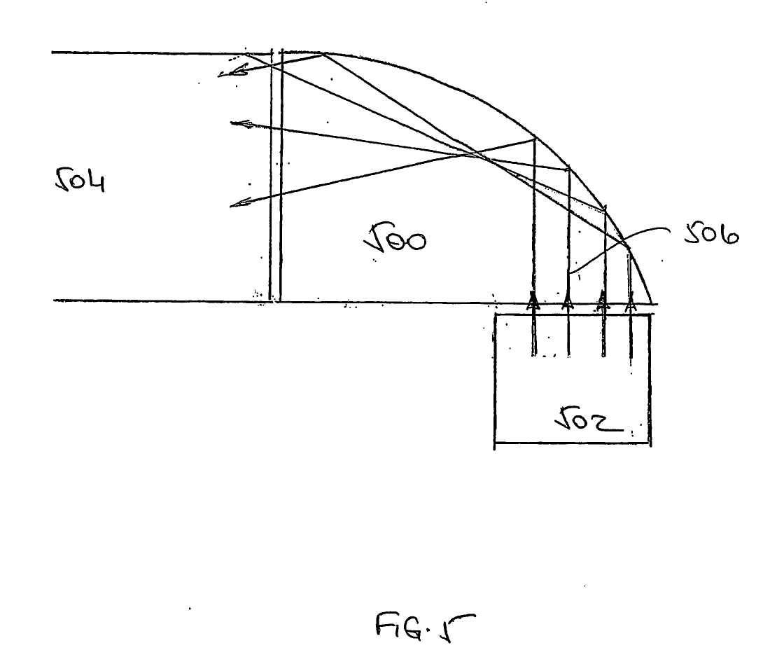

In use, light traveling in the WG along axis 310 enters the MLR and is reflected from its envelope into PD 306. The reflecting (and WG-PD light coupling) action has been measured experimentally and simulated numerically. Experimental results are shown in FIG. 4a. Simulation results are shown in FIG. 4b. Details are provided in a paper by M. Nathan, “Microlens reflector for out-of-plane optical coupling of a waveguide to a buried silicon photodiode”, to appear in Appl. Phys. Lett., Oct. 4, 2004, which is incorporated herein by reference. Coupling efficiencies of ca. 75% were measured and supported by the simulations.

To summarize to this point, an MLR of the present invention may thus also be described as defined by a curved envelope section separating the light transparent material from a first external medium (e.g. air), a first flat envelope section separating the MLR material from a second external medium (e.g. a silicon substrate with a buried PD), and a second flat envelope section positioned substantially vertical to the first flat section and separating the MLR material from a third external medium (e.g. a SU8 waveguide), whereby light entering said component from the second external medium is reflected from the curved envelope section into the third external medium.

It is noteworthy that without a MLR as described above, the normal mechanism for coupling light from the WG into the buried PD is by leakage (evanescent mode) over the coupling (overlap) length, as explained in more detail in Nathan 2003, as well as in section 2.2 of Levy 2003. This is quite an inefficient process. The efficiency may be increased by positioning a planar or concave micromirror or other reflecting element at a correct angle/position to reflect the light exiting the WG facet into the photodiode. However, this is a very complicated and expensive solution. Other possibilities (not shown, but described in Nathan 2003, Levy 2003 and the references therein) are to form a reflector such as a DBR on top of the WG in the overlap region, or a diffraction grating at the WG/PD overlap interface. These solutions are also quite complicated and expensive, particularly if applied to arrays of many WG/PD couples. Therefore, the MLR of the present invention provides an elegant solution to a long-standing problem of “bending” light 90° from a WG and coupling it into a PD.

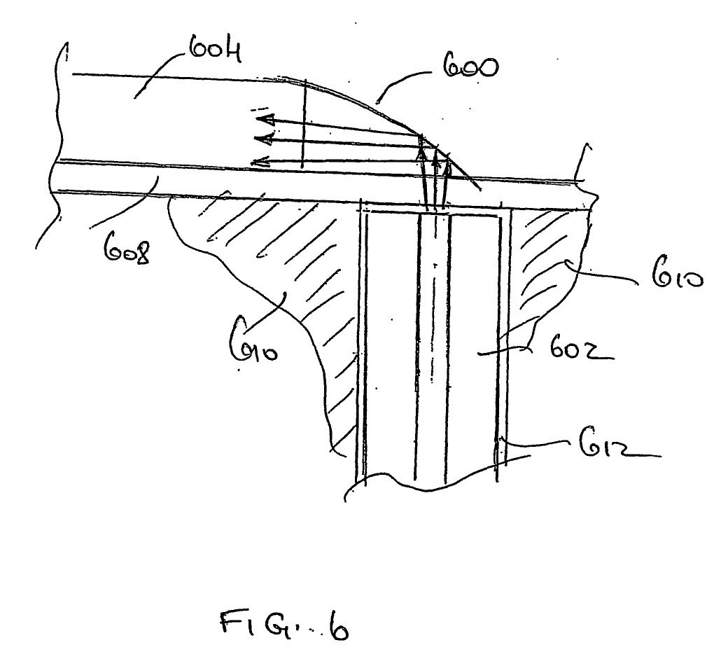

FIG. 5 shows schematically a preferred embodiment of an integrated MLR 500 used for coupling light between a vertically emitting light source (VCSEL or LED) 502 and a horizontal WG (or fiber) 504. Only a few rays of many are shown. The geometry is essentially a mirror image of the WG/PD coupling in FIG. 3, with the light source replacing the PD, and with light emitted by the source in a vertical direction 506 reflected by the MLR at essentially 90° into the WG. The MLR positioning and shape can be optimized to provide maximum reflection. In contrast with the prior art solutions described above, the MLR arrangement shown in FIG. 5 is simple to fabricate as a single component as well as in large arrays, the materials used are inexpensive, and the processes are well known and completely compatible with microelectronic and MEMS processes. Specifically, the use of an MLR as described removes the necessity of forming a 45° mirror on the end facet of the waveguide (or fiber), as described e.g. in Y. Ohmori et al., Thin Solid Films, 393, pp. 267-272, 2001. Therefore, the MLR of the present invention provides an elegant solution to a long-standing problem of “bending” light 90° from a light emitting source and coupling the light into a WG or fiber.

FIG. 6 shows schematically yet another preferred use of the MLR of the present invention, this time to couple light from a light fiber into a WG. Such coupling is one of the major bottlenecks in integrated optics for communications and/or computing. The reverse coupling from a WG into a fiber is similarly possible by the same principle. The discussion follows re. fiber-to-WG coupling, with the understanding that it applies equally well to WG-to-fiber coupling. Fiber-to-WG coupling schemes include butt-coupling, end-fire coupling, use of parabolic concentrators, and diffraction gratings. In all cases (except in the use of gratings) the fiber and WG are essentially parallel (in the same plane). This type of coupling is a basic feature in 2D optical switches (cross connects). Integrated optics chips and optical switches may be configured to have a large number of relatively small cross section (a few to a few tens of square micrometers) WGs that need to be coupled externally to much larger cross section fibers. The coupling may be bidirectional (input/output). The density of optical input/output ports in a 2D configuration is by necessity limited by the fiber size.

3D switches provide a high number of input/output ports, and consist of a matrix of planar 2D mirrors that can be tilted independently to redirect an incoming beam to any other mirror on either another or the same mirror matrix (see e.g. Symes and Moore above and M. Zickar, W. Noell, C. Marxer and N. de Rooij, Proc. SPIE vol. 5455, pp. 212-219, 2004 and references 9-12 cited therein). Micromirror switches involve extremely complicated MEMS technology with moving mirrors and actuators. Exemplarily, Zickar et al. have demonstrated 4×4 and 8×8 switches, based on 140 μm long, 100 μm high mirrors on 250 μm pitches, designed to couple to commercial ribbon optical fibers. The actual light coupling efficiency of these switches is apparently quite low. Inventively, the present invention discloses a totally new and novel 3D fiber/WG coupling architecture, applicable to 3D optical switches. Advantageously, in contrast with prior art, this architecture is truly 3 dimensional, providing a significantly higher count of inputs/outputs.

In FIG. 6, an integrated MLR 600 is used to couple light from a vertical fiber 602 into a horizontal WG 604 in a 90° out-of-plane coupling scheme. The MLR and the WG may be positioned on a flat thin layer 608 (e.g. of SiO₂), which may be further positioned on a substrate 610 (e.g. Si). The fiber may be inserted through a vertical hole 612 in substrate 610 and brought to close proximity with layer 608, which, in the area over the hole, serves as a transparent membrane. “Vertical” and “horizontal” are used here exemplarily as a general indication of orthogonality. Orthogonality, although preferred, is not essential, and in fact the WG and fiber may be coupled at angles different than 90°. In essence, fiber 602 has an identical function to vertical light source 502 in FIG. 5. In this embodiment, the MLR can couple optically a component on one plane of a substrate (the WG) with components on a different plane (of the same substrate or a separate substrate). In essence, this is a true 3D coupling scheme. The inverse coupling (from a WG into a fiber) is equivalent to the WG/PD coupling of FIG. 3. This novel fiber/WG coupling architecture provides unique possibilities for 3D optical cross connects and switches.

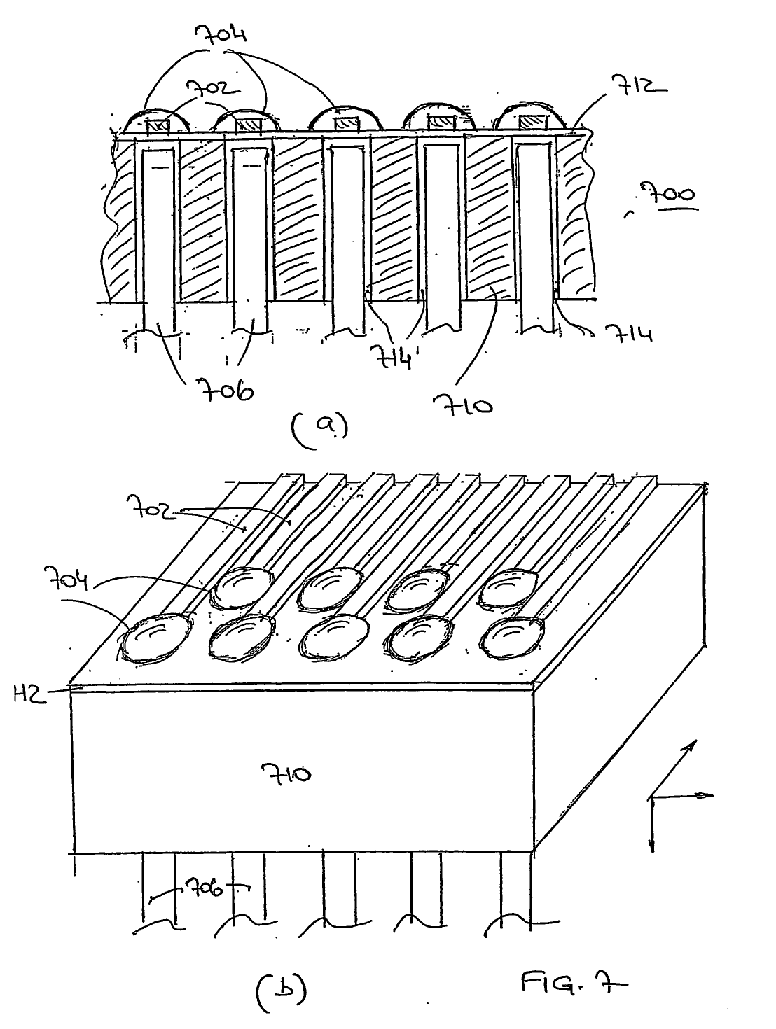

FIG. 7 shows schematically in (a) cross section and in (b) isomeric view an embodiment of an integrated optical chip 700 with a plurality of M WGs 702 coupled through respective MLRs 704 to a plurality of N vertical fibers 706. The WGs may represent on-chip components of a M×N optical switch/cross connect. In a particular case M=N. Exemplarily, chip 700 may use an oxidized silicon wafer 710 with a top oxide layer 712 as a substrate on which the WGs are fabricated. The WGs may be for example SU8 WGs. The silicon wafer is provided with an array of vertical (orthogonal to the WGs) holes 714, formed for example by etching the wafer from the back, with the oxide layer forming an etch stop. The oxide left over each hole is a transparent membrane, with a thickness that may vary from essentially a few Angstroms to a few micrometers. Each hole accommodates a respective fiber 706. We are not aware of any prior art that suggests such a “through the substrate” optical via. The holes may be fabricated with diameters that are only slightly larger than the fiber diameter, providing an additional self-alignment feature. Moreover, the holes may be fabricated by wet anisotropic etching from the back plane, providing truncated pyramids. The pyramids may be designed to stop the penetration of the fiber into the hole at an exact desired distance from the membrane. One can therefore obtain an exact distance between the fiber end and the WG plane. In other words, one can obtain an exact distance of an optical path between the end facet of the fiber, and the MLR curved reflecting surface.

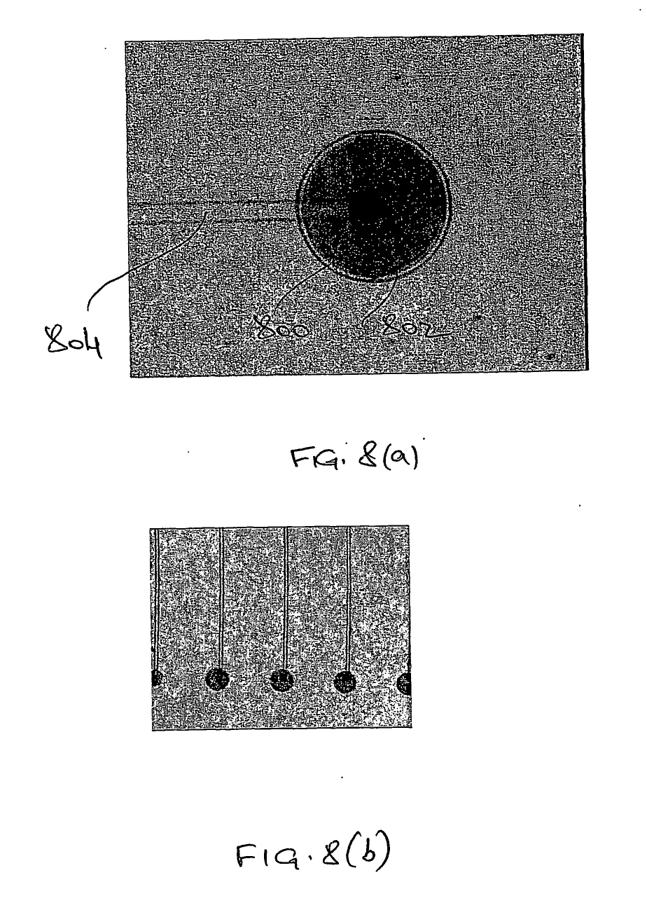

Each WG is positioned relative to a respective substrate hole such that an MLR can be formed to couple light from a respective fiber into the WG. FIG. 8a shows a top optical microscope view of an MLR 800 on an oxide membrane 802 covering a silicon hole, the MLR partially overlapping a WG 804. FIG. 8b shows a row of such MLR/WG structures on top of holes formed in a silicon substrate from the back. The structures shown were fabricated in out laboratory. Although only one row is shown in FIG. 8b, it is clear that full matrices of N rows by M columns may be fabricated. This arrangement provides a parallel coupling scheme for coupling light from an array of fibers into an array of WGs, particularly useful in integrated optics chips and 3D optical cross connects. It is clear that the number of light fibers that can be coupled through a substrate area is much larger than the maximum number that can be coupled through the substrate perimeter. For a square chip with an area of L×L and assuming the fiber diameter is L/10, a maximum of 40 fibers may be coupled through the perimeter (10 to a side, on a pitch L), while a much larger number (at least 100 and potentially 100√2) can be coupled from the back plane. Therefore, the MLR of the present invention provides an elegant solution to a long-standing problem of increasing the number of optical inputs/outputs of an integrated optical chip or optical cross connect, and achieving truly 3D architectures.

In summary, the present invention discloses a novel integrated micro-reflector based on a microlens. The microlens functions as a stationary micromirror. In contrast with existing solutions for light coupling in integrated structures, the MLR of the present invention is simple to fabricate as a single component as well as in large arrays, and requires inexpensive materials and well established processes that are completely compatible with microelectronic and MEMS processes.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1-50. (canceled)

51. A reflecting micro-optical component comprising a microlens operative to couple light between first and second micro-optical components through total internal reflection of the light inside the microlens.

52. The reflecting micro-optical component of claim 51, wherein the microlens includes a curved envelope section and at least two non-parallel flat envelope sections, and wherein the light enters the microlens through one flat section, exits the microlens through a different flat section and is reflected internally at the curved envelope section.

53. The reflecting micro-optical component of claim 51, wherein the microlens includes a material transparent to light of a predetermined wavelength.

54. The reflecting micro-optical component of claim 53, wherein the material is a photoresist.

55. The reflecting micro-optical component of claim 53, wherein the material is a glass.

56. The reflecting micro-optical component of claim 52, further comprising a thin reflecting layer covering the curved envelope section.

57. The reflecting micro-optical component of claim 51, wherein the reflecting layer is a metal.

58. The reflecting micro-optical component of claim 51, wherein the first micro-optical element and the second micro-optical element are respectively a waveguide and a photodetector.

59. The reflecting micro-optical component of claim 51, wherein the first micro-optical element and the second micro-optical element are respectively a light source and a waveguide.

60. A reflecting microlens comprising:
a. a curved envelope section separating a light transparent material from a first external medium;
b. a first flat envelope section separating the light transparent material from a second external medium; and
c. a second flat envelope section positioned substantially vertical to the first flat section and separating the light transparent material from a third external medium;
whereby light entering the microlens from the second external medium is totally internally reflected from the curved envelope section into the third external medium.

61. The reflecting microlens of claim 60, wherein the light transparent material is selected from the group of a photoresist and a glass.

62. The reflecting microlens of claim 60, further comprising a thin reflecting layer covering the curved envelope section.

63. The reflecting microlens of claim 62, wherein the reflecting layer is a metal.

64. The reflecting microlens of claim 60, wherein the second external medium is a waveguiding medium and wherein the third external medium is a photodetecting medium.

65. The reflecting microlens of claim 62, wherein the second external medium is a light emitting medium and wherein the third external medium is a waveguiding medium.

66. The reflecting microlens of claim 64, integrated on a substrate that includes the photodetecting medium and supports the waveguiding medium.

67. The reflecting microlens of claim 66, wherein the substrate is silicon.

68. A method of coupling light between first and second micro-optical components, comprising the steps of:
a. forming a microlens reflector operative to reflect light from the first to the second micro-optical component by total internal reflection; and
b. coupling light from the first to the second micro-optical component.

69. The method of claim 68, wherein the step of forming a microlens includes forming a photoresist microlens having a curved external surface.

70. The method of claim 69, wherein the step of forming a microlens further includes forming a thin reflecting layer over the curved external surface.
